(19) United States
(12) Patent Application Publication
(10) Pub. No.: US 2012/0158410 A1
(43) Pub. Date: Jun. 21, 2012

(54) DIGITAL AUDIO SIGNAL PROCESSING SYSTEM

(75) Inventors: Jonas Lundbäck, Vellinge (SE); Johannes Sandvall, Lund (SE)

(73) Assignee: ST-ERICSSON SA, Plan-les-Ouates (CH)

(21) Appl. No.: 13/381,611

(22) PCT Filed: Jun. 17, 2010
(86) PCT No.: PCT/EP2010/058531

§ 371 Date: Mar. 6, 2012

Related U.S. Application Data
(60) Provisional application No. 61/228,217, filed on Jul. 24, 2009.

(30) Foreign Application Priority Data
Jul. 7, 2009 (EP) 09164705.7

(51) Int. Cl. G10L 19/00

(52) U.S. Cl. 704/500; 704/E19.001

(57) ABSTRACT

A digital audio signal processing system is disclosed that enable flexible coexistence of signals having different formats in the same hardware architecture. The system comprises at least one input, at least one first format transformer, and at least one digital audio signal processor. The at least one input is arranged to receive at least a first digital audio signal having a first format comprising a first symbol resolution and a first symbol distribution. The at least one first format transformer is arranged to transform the first digital audio signal to a second digital audio signal having a second format comprising a second symbol resolution which is different from the first symbol resolution and a second symbol distribution which is different from the first symbol distribution based on at least a first parameter and a second parameter, wherein the first parameter is associated with a number of integer symbols of the second format and the second parameter is associated with a number of fractional symbols of the second format. The at least one digital audio signal processor is arranged to process the second digital audio signal to produce a third digital audio signal. Corresponding computer program product is also disclosed.

### TECHNICAL FIELD

The present invention relates generally to the field of digital audio signal processing system. More particularly, it relates to digital audio signal processing systems handling digital audio signals of different formats.

### BACKGROUND

In the technical field of digital audio signal processing systems as applied in portable devices such as mobile phones, functionality has grown from elementary playing and/or recording functionality to more advanced functionality. For example, such more advanced functionality may include units such as multiple audio decoders and encoders (codecs) and audio effect units (e.g. dynamic range controller and equalizer), and structures that enable mixing of audio sources and/or routing of audio signals to different destinations (e.g. speakers or headphones).

Most music players and portable devices with audio reproduction capabilities have a digital audio signal processing system hardware architecture employing a fixed-point processor for the audio processing.

FIG. 1 illustrates an example representation of an audio signal sample in and its corresponding format. The bit representation 10 comprises a number of bits. The number of bits corresponds to the bit resolution 20 of the format. In the bit representation 10, a decimal point 30 divides the number of bits into bits representing the integer part of the audio signal sample (integer bits) and bits representing the fractional part of the audio signal sample (fractional bits). The location of the decimal point 30 within the bit representation 10 corresponds to the bit distribution of the format. It is to be understood that references to bits (e.g. in a sample representation as above) is meant to include generalizations to any symbols (e.g. quaternary, decimal or hexagonal symbols) throughout the description.

Implementation of audio processing algorithms on fixed-point hardware can utilize neither floating-point representation nor floating-point operations, since this is too expensive in terms of resources, which is particularly important in portable devices. Thus, implementations of audio processing algorithms are carried out in fixed-point arithmetic, where the bits used to represent a sample is divided into integer bits and fractional bits according to a predetermined format. Hence, the bit resolution of an audio sample is fixed and the decimal point is set to a specific location within the bit pattern representation of the audio sample. The corresponding format is denoted the Q-format.

The subdivision into integer and fractional bits is a very important task. It has implications on the resulting output audio quality. It also affects the amount of resources (e.g. code size, computational power) required to obtain a desired output. The bit distribution configuration being done explicitly in the implementation imposes large limitations on both flexibility and performance of the digital audio signal processing.

An evaluation of a device which is capable of reproducing audio (an audio rendering device) may involve a range of functionalities, e.g. in terms of supported audio formats and audio enhancement capabilities. An important factor in an evaluation may be the quality of the rendered audio. The audio quality (often quantified and measured as a signal-to-noise ratio or signal-to-noise-and-distortion ratio using a predefined set of audio tracks) is frequently reported in papers and magazines for various devices and may be highly important from a marketing perspective.

At present, most digital audio tracks (sampled and coded audio, e.g. music) are represented using 16 bit resolution. However, several codecs are known that support higher resolution, e.g. Free Lossless Audio Codec (FLAC—a lossless audio compression/decompression) with 20 bits resolution.

Although also depending on the type of codec used, increasing the number of bits in the bit resolution may increase the quality of the digital audio track, thus making it more similar to the original audio track that was digitized. Thus, to maintain audio quality after processing, it would be desirable to be able to use a higher bit-resolution. For example, additional bits (precision bits) may be used to represent more of the fine details of an audio sample. Use of more precision bits effectively decreases the quantization noise (commonly referred to as decreasing or lowering the noise floor). Quantization noise may, for example, be introduced when digitizing the audio sample and/or during the performance of arithmetic operations on the digital audio sample.

As there are variations in bit resolution of digital audio tracks increases and as the availability of audio processing blocks with higher bit resolution increases, implementations of audio processing algorithms carried out in fixed-point arithmetic (according to a predetermined format) will be an obstacle when trying to design systems that support both high and low resolution audio tracks. For example, it will be cumbersome (if not impossible) to design a system that supports all relevant formats yielding a desired audio quality for each format and optimizing resource utilization by the audio signal processing system.

Thus, there is an increasing need for co-existence of digital audio signals with different bit resolutions (and/or different bit distributions) on the same hardware architecture of a digital audio signal processing system. There is also a need for such systems having increased flexibility in terms of target quality and resource optimization.

### SUMMARY

It should be emphasized that the term “comprises/comprising” when used in this specification is taken to specify the presence of stated features, integers, steps, or components, but does not preclude the presence or addition of one or more other features, integers, steps, components, or groups thereof.

It is an object of the invention to obviate at least some of the above disadvantages and to provide digital audio signal processing systems and corresponding computer program products that enable flexible co-existence of signals having different formats in the same hardware architecture.

According to a first aspect of the invention this is achieved by a digital audio signal processing system comprising at least one input, at least one first format transformer, and at least one digital audio signal processor. The at least one input is arranged to receive at least a first digital audio signal having a first format comprising a first symbol resolution and a first symbol distribution. The at least one first format transformer is arranged to transform the first digital audio signal to a second digital audio signal having a second format comprising a second symbol resolution which is different from the first symbol resolution and a second symbol distribution which is different from the first symbol distribution based on at least a first parameter and a second parameter, wherein the first parameter is associated with a number of integer symbols of the second format and the second parameter is associated with a number of fractional symbols of the second format. The at least one digital audio signal processor is arranged to process the second digital audio signal to produce a third digital audio signal. Each symbol may consist of a bit in some embodiments.

In some embodiments, the third digital audio signal may have a third format comprising a third symbol resolution which is equal to the second symbol resolution and a third symbol distribution which is equal to the second symbol distribution. In such embodiments, the digital audio signal processing system may further comprise at least one second format transformer and at least one output. The at least one second format transformer may be arranged to transform the third digital audio signal to a fourth digital audio signal having a fourth format comprising a fourth symbol resolution which is different from the third symbol resolution and a fourth symbol distribution which is different from the third symbol distribution based on at least a third parameter and a fourth parameter, wherein the third parameter is associated with a number of integer symbols of the fourth format and the fourth parameter is associated with a number of fractional symbols of the fourth format. The at least one output may be arranged to provide at least the fourth digital audio signal.

In some embodiments, the first parameter may comprise the number of integer symbols of the second format and the second parameter may comprise the number of fractional symbols of the second format. In such embodiments, the first format transformer may comprise at least one compressor arranged to compress the first digital audio signal. The compressor may be arranged to compress the first digital audio signal if the absolute value of the maximal amplitude of the first digital audio signal exceeds Z^{Y}−1, where Y equals a sum of the number of integer symbols of the second format and a number of fractional symbols of the first format and where Z is the mathematical number base of the symbol representation. The first format transformer may comprise a format width adjuster arranged to append or remove a number of symbols to the first digital audio signal to provide the second digital audio signal with the second symbol resolution. The first format transformer may comprise a symbol distribution adjuster arranged to shift the first digital audio signal to provide the second digital audio signal with the second symbol distribution.

In some embodiments, the first format transformer may be arranged to transform a plurality of digital audio signals to a corresponding plurality of transformed digital audio signals each having a transformed format, which for each of the plurality of digital audio signals is based on at least a respective first parameter and a respective second parameter, wherein the respective first parameter comprises a number of integer symbols of the corresponding transformed format and the respective second parameter comprises a number of fractional symbols of the corresponding transformed format.

According to some embodiments, the first parameter may comprise an indication of a minimum number of headroom symbols of the second format and the second parameter may comprise an indication of a minimum number of precision symbols of the second format. The first format transformer may comprise a format width adjuster arranged to append a number of symbols to the first digital audio signal, wherein the number of symbols is equal to or larger than a sum of the minimum number of headroom symbols and the minimum number of precision symbols, to provide the second digital audio signal with the second symbol resolution. The first format transformer may comprise a symbol distribution adjuster arranged to shift the first digital audio signal to provide the second digital audio signal with the second symbol resolution. The first format transformer may be arranged to determine the second format based on the first and second parameters and on the first format of the first digital audio signal.

In some embodiments, the first format transformer may be arranged to transform a plurality of digital audio signals, each having a respective first format, to a corresponding plurality of transformed digital audio signals each having a same second format, based on at least the first parameter and the second parameter. The first format transformer may be arranged to determine the second format based on the first and second parameters and on the respective first formats of the plurality of digital audio signals. The second symbol resolution may be a sum of: the minimum number of headroom symbols, the minimum number of precision symbols, a maximum number of integer symbols among the respective first formats, and a maximum number of fractional symbols among the respective first formats.

In some embodiments, the first format converter may be further arranged to tag the second digital audio signal with an indicator of the second format.

A second aspect of the invention is an electronic apparatus comprising the system according to the first aspect of the invention. The electronic apparatus may, in some embodiments, be an audio rendering device, a media player, a communication device, or a mobile telephone.

A third aspect of the invention is a computer program product comprising a computer readable medium, having thereon a computer program comprising program instructions, the computer program being loadable into a data-processing unit of an audio processing device and adapted to cause the data-processing unit to execute, when the computer program is run by the data-processing unit, at least the following steps. Receiving at least a first digital audio signal having a first format comprising a first symbol resolution and a first symbol distribution. Transforming the first digital audio signal to a second digital audio signal having a second format comprising a second symbol resolution which is different from the first symbol resolution and a second symbol distribution which is different from the first symbol distribution based on at least a first parameter and a second parameter, wherein the first parameter is associated with the number of integer symbols of the second format and the second parameter is associated with the number of fractional symbols of the second format. Processing the second digital audio signal to produce a third digital audio signal.

In some embodiments, the third aspect of the invention may additionally have features identical with or corresponding to any of the various features as explained above for the first aspect of the invention.

An advantage of some embodiments of the invention is that systematic handling and co-existence of digital audio signals with arbitrary bit-resolution and arbitrary bit-distribution representation on a hardware architecture based on fixed-point processor(s) is provided.

Another advantage of some embodiments of the invention is that conversion between different bit-resolutions and bit-distributions is automatic. This may provide flexibility to a very small cost. In some embodiments, the only required additions in terms of operations are basic processor operations. In some embodiments, compression functionality is also a required addition.

Another advantage of some embodiments of the invention is that scalable format of digital audio signals is provided. This may enable saturation protection via use of headroom symbols and/or compression functionality. Thus, in some embodiments, it will not be necessary to perform an initial volume decrease to create headroom. Thereby a decrease of the signal-to-noise ratio may be avoided.

Another advantage of some embodiments of the invention is that flexibility is provided that enable addition of symbols to preserve details of the audio signal. Thereby, the noise floor may be lowered. When the noise floor is lowered, a volume decrease will not necessarily result in loss of signal details. Thus, a high signal-to-noise ratio may be preserved.

Another advantage of some embodiments of the invention is that an audio system according to embodiments of the invention may be configured to emphasize on either or both resource saving and high-quality audio processing. Thus, flexibility is provided in the trade-off between resource efficiency and audio quality.

Another advantage of some embodiments of the invention is that audio processing that depends on the bit-resolution and the bit-distribution of the input and output signals may adjust dynamically to the current settings. Hence, audio processing algorithms can be implemented to support either or both of resource efficient processing and high-quality processing.

Another advantage of some embodiments of the invention is that the provided scalable formats enable migrations to general hardware architectures. For example, the format may be adapted to a format supported by busses of the architecture, and to D/A (digital-to-analog) converters with selectable bit-resolution.

Another advantage of some embodiments of the invention is that a possibility to move between different hardware architectures while maintaining a high level of optimization with respect to both audio quality and resource efficiency is provided.

### BRIEF DESCRIPTION OF THE DRAWINGS

Further objects, features and advantages of the invention will appear from the following detailed description of embodiments of the invention, with reference being made to the accompanying drawings, in which:

FIG. 1 is a schematic illustration of a format of a digital audio signal;

FIG. 2A is block diagrams illustrating two example arrangements according to some embodiments of the invention;

FIG. 2B is a block diagram illustrating an example digital audio signal processing system according to some embodiments of the invention;

FIG. 3 is a block diagram illustrating an example format aligner according to some embodiments of the invention;

FIG. 4 is a flowchart illustrating example method steps according to some embodiments of the invention;

FIG. 5 is a block diagram illustrating an example format converter according to some embodiments of the invention;

FIG. 6 is a block diagram illustrating an example format converter according to some embodiments of the invention;

FIG. 7 is a flowchart illustrating example method steps according to some embodiments of the invention;

FIG. 8 is a flowchart illustrating example method steps according to some embodiments of the invention; and

FIG. 9 is a schematic drawing illustrating an example audio rendering device, which may comprise one or more digital audio signal processing systems according to some embodiments of the invention.

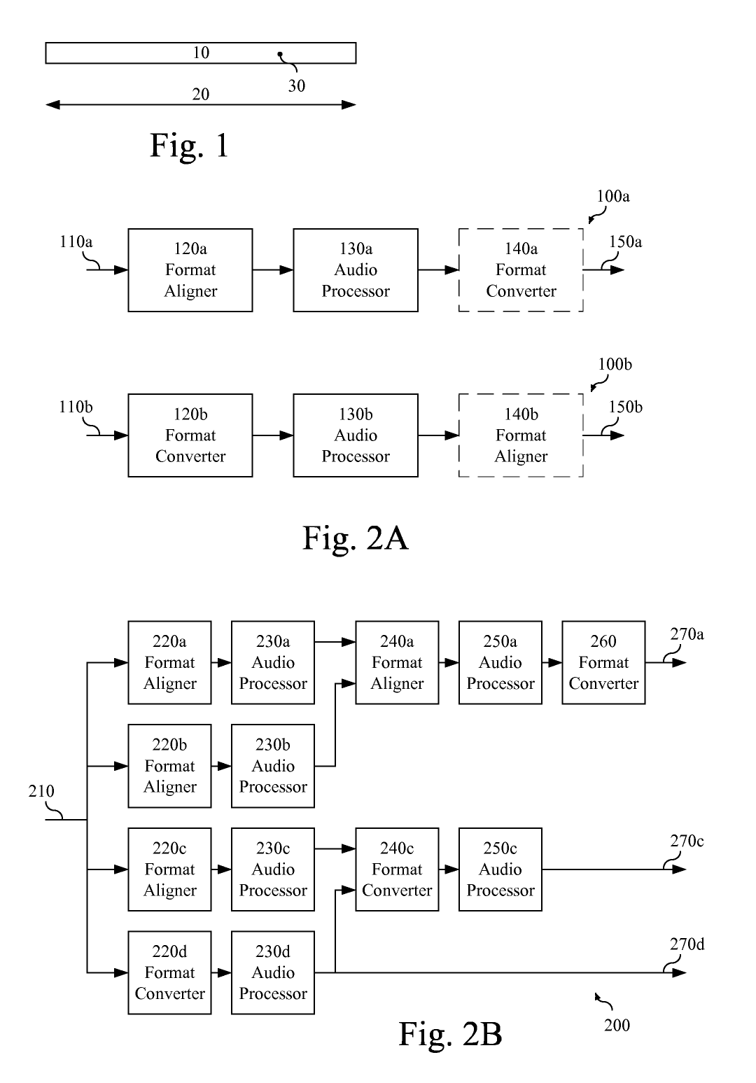

### DETAILED DESCRIPTION

In the following, embodiments of the invention will be described where flexible co-existence of signals having different formats in the same architecture is enabled. Embodiments of the invention thus provides means for using fixed-point digital audio processing (e.g. in an audio processing algorithm requiring a predetermined fixed-point format) while still being able to use different variable signal format (resolution and distribution). Embodiments of the invention enable signals of different formats to be combined and/or processed using the same architecture. According to embodiments of the invention also enable use of processing units requiring different signal formats to be used and combined in the same processing chain.

Embodiments of the invention also provide for flexible trade-off between optimizing audio quality (e.g. using higher resolution that may or may not be optimal for the hardware architecture) and optimizing resource utilization (e.g. power consumption, hardware utilization, employing audio processing software that is optimized to the hardware architecture and thereby reduces power consumption).

Embodiments of the invention make the trade-off configurable. Thus, a potential user can focus on resource management (e.g. power consumption) or increased quality of the listening experience (e.g. utilizing higher resolution in audio processing, which may result in increased power consumption for example).

This trade-off possibility may, for example, be used by a (software or hardware) designer of the audio processing system, by an application or device designer when incorporating the audio processing system into an application or a device, or even by an end user when using the application or device. In the latter case, the end user may, for example, have the possibility to set the audio quality of different applications of a device (e.g. high quality for music rendering, medium quality for speech rendering in a telephone conversation, low quality for ring signals) and thereby implicitly setting resource utilization.

As mentioned above, most music players and portable devices with audio reproduction capabilities have a digital audio signal processing system hardware architecture employing a fixed-point processor for the audio processing. A standard device may employ a 16 bit fixed-point processor while more advanced devices may potentially include a 20, 24 or 32 bit fixed-point processor with or without floating-point capabilities.

As digital audio tracks with more than 16 bit resolution become more common there will be a need for co-existence of digital audio signals with different bit resolutions on the same hardware architecture, for example, to provide backward compatibility (e.g. an “old” 16 bit resolution audio track should be able to be processed using the same audio processing system as a “new” 24 bit resolution audio track). Further, it is not always recommendable or even possible to simply convert the lower resolution tracks to the higher resolution format, since, for example, this may not be optimal for the hardware architecture in question and/or may impair stability, functionality and/or development time of the audio signal processing system.

In some situations there may be multiple audio destinations (sinks). In such situations the different destinations may or may not require different formats (that may be different from the format supplied by the audio system output), for example to fit either software or hardware restrictions of the destinations.

Further, in an audio rendering device where Digital-to-Analogue (D/A) converters and bus mechanisms support variable bit-resolution, there will be a need to support audio processing with variable bit-resolution. This would render possible a system where a user/designer has the possibility to decide if a high or low bit-resolution is to be used throughout an entire audio chain, i.e. all the way from an audio decoder to an audio output device (e.g. loudspeaker or headphone).

In playback mode (when an audio track is played) the audio path from decoder to output device often includes audio processing blocks that are used to enhance the listening experience (for example volume gain controls). The nature and purpose of an audio effect resulting from such an audio processing block in general may or may not render a resulting amplification of the amplitude in the output signal compared to the input signal of the audio processing block. To preserve audio quality there is a need to control that the amplitude of the digital audio signal can be represented with the selected bit resolution and bit distribution, and to assert that no saturations (due to overflow in an arithmetic operation) occur. This can be achieved by introducing headroom (i.e. additional most significant bits) in the representation of an audio sample. Also to preserve audio quality, precision bits (i.e. additional least significant bits) may be introduced in the representation of an audio sample, which lowers the so called noise floor. For example, an audio processing algorithm may result in a signal that requires more fractional bits to be fully represented than did the original audio signal. In such a case, precision bits may be helpful to avoid loss of quality. Introduction of headroom and/or precision bits may change the format and is therefore enhances the need for co-existence of signals with different formats.

In some known audio processing systems an early volume decrease is used to create headroom within the bits resolution used to represent the samples of an audio signal before audio processing is applied. This, however, decreases the signal-to-noise ratio (and thereby the audio quality) since the audio signal is attenuated before the audio processing and more quantization noise (e.g. noise introduced in calculations due to finite bit resolution) is introduced in the processing. Fine details of the audio samples are thus discarded.

Furthermore, it may be desirable to optimize the audio processing based on one or both of the audio quality of the processed signal and the resource utilization of the system or of particular processing units of the system.

Implementations on specific hardware architectures are usually optimized in terms of resource management where the bit resolution as well as the bit distribution is fixed, leaving no room for flexibility. Thereby, management by e.g. a software designer of the fixed bit resolution and bit distribution may result in a poorly configured audio processing unit in terms of quality and/or resource utilization.

If nothing is done to simplify, improve and/or promote the possibilities for co-existence on the same hardware architecture of signals having different formats and/or processing units (e.g. audio processing algorithms) requiring different formats a situation may result where the audio processing is not performed in an optimal way with respect to the hardware architecture and/or the audio quality.

Embodiments of the invention provide audio reproduction systems that are flexible in terms of bit-resolution and bit-distribution and thereby overcome at least some of the above disadvantages. Embodiments of the invention thus facilitate audio processing employed on fixed-point hardware architecture in that the format representation of audio samples may be dynamically adjusted.

Embodiments of the invention provides for conversion from one format into another format, while avoiding audio distortions. In some embodiments, a reference level (e.g. for volume and amplitude control) may be maintained.

A systematic approach to enable digital audio processing of digital audio signals with variable bit resolution and variable bit distribution on a fixed-point processor based hardware architecture is provided.

Embodiments of the invention provide protection against overflow by providing a mechanism for introducing headroom bits. Further, embodiments of the invention enable high quality audio processing by providing a mechanism to decrease the noise floor and preserving fine details of the audio samples by introducing precision bits, thereby reducing the calculation noise and maintaining a high signal-to-noise ratio.

Embodiments of the invention also provide flexibility of the audio processing system design. For example, a possibility is provided to employ audio processing algorithms that have different requirements on the digital audio signal representation and/or that are optimized for different purposes (e.g. high-resolution processing or resource saving). Flexibility is also provided in that embodiments of the invention may support a mixture of digital audio signals with different bit-resolution and bit-distribution (as inputs to, outputs from, and/or internally in the digital audio processing system). Furthermore, audio processing systems according to embodiments of the invention may be easily reconfigured if the system is moved between different hardware architectures.

FIG. 2A illustrates two example audio processing chains 100a, 100b according to some embodiments of the invention.

The audio processing chain 100a receives, at 110a, N input signals with respective (possibly different) bit resolution and/or bit distribution. The N signals are input to a format aligner 120a, where the signals are aligned such that the resulting signals have the same format (i.e. the same bit resolution and bit distribution). The format aligner may also provide for introduction of headroom and/or precision bits. Then, the aligned signals are provided to an audio processor 130a (or audio processing core) where the actual audio processing takes place according to any known or future audio processing algorithms (e.g. mixing, amplifying, equalizing, filtering, etc). The thus processed K signal(s) have respective formats (possibly different from the input format, and possibly different among the K processed signals). If the audio signal sink, 150a (e.g. loudspeaker, headphone, or further audio processing), requires a different format than the format of the K processed signals, a format converter 140a is provided, which converts the K processed signals to K converted signals with the required formats.

The audio processing chain 100b receives, at 110b, N input signals with respective (possibly different) bit resolution and/or bit distribution. The N signals are input to a format converter 120b, where the signals are converted to N converted signals with the respective formats as required by the audio processor 130b (or audio processing core). In the audio processor 130b, the actual audio processing takes place according to any known or future audio processing algorithms (e.g. mixing, amplifying, equalizing, etc). The thus processed K signal(s) have respective formats (possibly different from the input format, and possibly different among the K processed signals). If the audio signal sink, 150b (e.g. loudspeaker, headphone, or further audio processing), requires that the K processed signals have the same format and that format is different from the format of the K processed signals, a format aligner 140b is provided, which aligns the K processed signals such that the resulting signals have the same format (i.e. the same bit resolution and bit distribution) as required by the sink 150b. The format aligner may also provide for introduction of headroom and/or precision bits, which may be applicable if, for example, the sink comprises further audio processing.

The format aligners 120a, 140b and the format converters 120b,140a of FIG. 2A are used to align/convert the signals before processing and after processing (if required). This approach provides flexibility in terms of selecting the appropriate version of audio processing algorithm (130a, 130b). The approach also enables support of several output formats.

FIG. 2B illustrates an example digital audio signal processing system 200 according to some embodiments of the invention. This example audio signal processing system comprises a collection of sources 210, audio processors (algorithms) 230a, 230b, 230c, 230d, 250a, 250c, and sinks (destinations) 270a, 270c, 270d. The example audio signal processing system 200 also comprises a number of format aligners 220a, 220b, 220c, 240a and format converters 220d, 240c, 260. The example audio signal processing system 200 may in fact be viewed as a combination of several audio processing chains 100a, 100b as described in FIG. 2A.

At 210, the system receives one or more audio signals having respective (possibly different) formats. Each of the signal processing chain initial blocks 220a, 220b, 220c, 220d may receive one or more of the one or more audio signals received at 210, and any of the one or more audio signals received at 210 may be input to one or more of the signal processing chain initial blocks 220a, 220b, 220c, 220d.

Starting from the top of FIG. 2B, N₁ signals are input to a format aligner 220a, where the signals are aligned such that the resulting signals have the same format. The format aligner may also provide for introduction of headroom and/or precision bits. Then, the aligned signals are provided to an audio processor 230a. This part of the system may, for example, be designed with a focus on high bit resolution calculations (e.g. to achieve high audio quality) with a requirement of headroom and a low noise floor.

Continuing downwards in FIG. 2B, N₂ signals are input to a format aligner 220b, where the signals are aligned such that the resulting signals have the same format. This format may or may not be different from the format output from format aligner 220a. As above, the format aligner may also provide for introduction of headroom and/or precision bits. Then, the aligned signals are provided to an audio processor 230b. This part of the system may, for example, be designed with a focus on low bit resolution calculations (e.g. to achieve low computational complexity and resource management) where no or small headroom is required and/or a high noise floor is accepted.

The thus processed signals, output from processors 230a and 230b, have respective formats (possibly different from the input format, possibly different between processor 230a and 230b, and possibly different among the processed signals from each of the processors). In the system 200, the outputs from processors 230a and 230b are input to a format aligner 240a, where the signals are aligned such that the resulting signals have the same format as required by the audio processor 250a. As always, the format aligner may provide for introduction of headroom and/or precision bits. The thus aligned signals are provided to the audio processor 250b. This part of the system may, for example, be designed with a focus on high bit resolution calculations (e.g. to achieve high audio quality) with a requirement of headroom and a low noise floor.

In this system, the audio signal sink 270a requires a different format than the format output from processor 250a. Therefore, a format converter 260 is provided, which converts the processed signals to signals with the required formats. The signal provided to sink 270a may be a high resolution signal.

Continuing further downwards in FIG. 2B, N₃ signals are input to a format aligner 220c, where the signals are aligned such that the resulting signals have the same format (possibly with introduction of headroom and/or precision bits). Then, the aligned signals are provided to an audio processor 230c. This part of the system may, for example, be designed with a focus on high bit resolution calculations (e.g. to achieve resulting signals that may be compressed without significant loss of quality) with a requirement of headroom and a low noise floor.

In the lower part of FIG. 2B, N₄ signals are input to a format converter 220d, where the signals are converted such that the resulting signals have the format(s) required by the audio processor 230d. Then, the converted signals are provided to the audio processor 230d. This part of the system may, for example, be designed for high bit resolution conversion for computational efficiency.

The thus processed signals, output from processors 230c and 230d, have respective formats (possibly different from the input format, possibly different between processor 230c and 230d, and possibly different among the processed signals from each of the processors). In the system 200, the outputs from processors 230c and 230d are input to a format converter 240c, where the signals are converted such that the resulting signals have the format(s) as required by the audio processor 250c. The thus converted signals are provided to the audio processor 250c. This part of the system may, for example, be designed with a focus on low computational complexity and resource management.

The audio signal sink 270c accepts the format output from processor 250c, and no further convention or alignment is required. The output from processor 230d is also supplied to audio signal sink 270d, that accepts the format output from processor 230d, and no further convention or alignment is required. The signals provided to sinks 270c and 270d may be low resolution signals.

In general, input and output signals of an audio signal processing system may have the same or differing formats. The formats of the input and/or output signals may depend on the audio application. In an audio signal processing system, audio processing devices may be employed that require a specific format. Several processing devices that require different formats may be used jointly. This is rendered possible by the use of format aligners and format converters, inserted at suitable places in the system to provide the required formats at each point in the system.

In general, the format aligner aligns the audio signals so that they have the same format (i.e. the same resolution and distribution, or put in another way, the same number of integer bits and the same number of fractional bits). Further, the format aligner may add bits to provide for headroom and to lower the noise floor. An indication of the required headroom and/or the required number of precision bits may be provided as inputs to the format aligner. Consequently, the resolution in number of bits is equal for all output signals after alignment, and is equal to or greater than the largest resolution of an input signal.

Generally, the format converter converts the audio signals from the input format(s) to signals with format(s) as determined by parameters provided as inputs to the format converter. The format converter may comprise compression capabilities (preferably with minimum audio distortion) so that conversion from a format to another format with a smaller bit-resolution is possible.

In some embodiments of the invention parameters indicating the current format (e.g. an indication of resolution and distribution, or an indication of the number of integer and fractional bits respectively) are tagged to the audio signals or otherwise propagated along with the audio signals. For example, a data structure used for describing an audio signal or a collection of audio signals may include one or more variables for this purpose. Alternatively or additionally, an audio data stream may comprise such indicators at certain time intervals, at system start up, and/or when the signal format is changed.

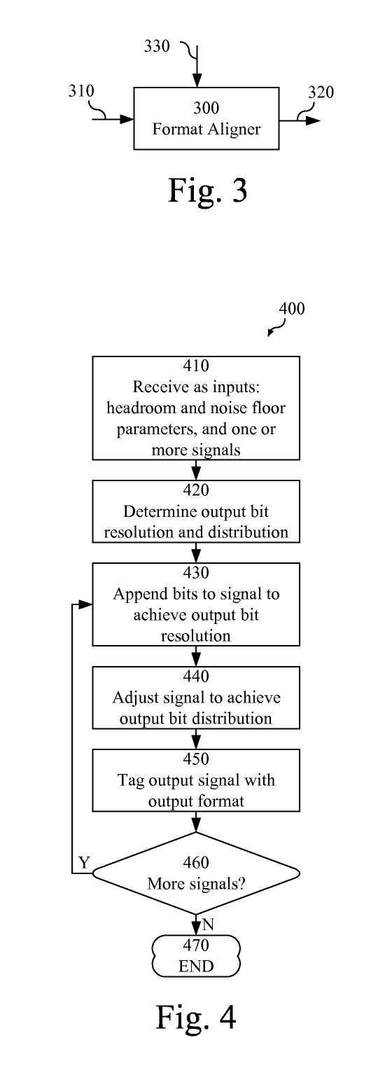

FIG. 3 illustrates an example format aligner 300. The format aligner accepts N_{AL} signals as input at 310 and outputs N_{AL} signals at 320. The signals input at 310 may have different format (i.e. different resolution and/or distribution, or put differently different number of integer and/or fractional bits), while the signals output at 320 have equal format, i.e. are aligned. The format aligner 300 may also receive parameters H and/or K as inputs at 330. H is a headroom parameter, for example indicating the minimum number of headroom bits required in the output signals. K is a noise floor (or precision) parameter, for example indicating the minimum number of precision bits required in the output signals. In some embodiments, either or both of the headroom parameter and the precision parameter may be disabled (functionally corresponding to setting H=K=0 in the description below).

FIG. 4 illustrates example operations 400 performed by the format aligner 300 of FIG. 3. At step 410, the format aligner receives the audio signal inputs and the headroom and noise floor parameters H and K.

In step 420, the resulting output format is determined. In some embodiments this may be done by setting

$$A = {max}_{i = 0 , 1 , … {N}_{AL} - 1} ( {A}_{i} + H ) and$$

$$B = {max}_{i = 0 , 1 , … {N}_{AL} - 1} ( {B}_{i} + K ) ,$$

where A and B is the number of integer and fractional bits respectively of the output format and Aᵢ and Bᵢ is the number of integer and fractional bits respectively of the format of input signal i.

Then, in steps 430 and 440, the input signals are transformed to the format determined in step 420. In this embodiment, the transformation is performed by appending a number of most significant bits to the signal sample in step 430. This step achieved the required format size (or width). The number of appended bits equals the number of fractional and integer bits that are missing in the signal sample to have the required resolution as determined in step 420, i.e. X=(A+B)−(Aᵢ+Bᵢ), where X is the number of appended bits. Then, in step 440, the signal is adjusted (e.g. by left-shifting the representation) to achieve the required distribution as determined in step 420. It is to be understood that other ways of transforming the signal format may be envisioned, and that the approach in steps 430 and 440 is merely an example. Other examples include appending X least significant bits and right-shifting the representation, or appending A−Aᵢ most significant bits and B−Bᵢ least significant bits.

In step 450, the output signal is tagged with an indicator of the format as determined in step 420 as explained above.

In step 460, it is determined whether there are more input signals to transform. If that is the case, the process returns to step 430 to transform another signal to the required format. Steps 430-460 are iterated until all input signals have been transformed. Then the process ends at step 470.

It is to be understood that steps 450 and 460 may be reversed in some embodiments of the invention, i.e. all the input signals are first transformed, then they are all tagged.

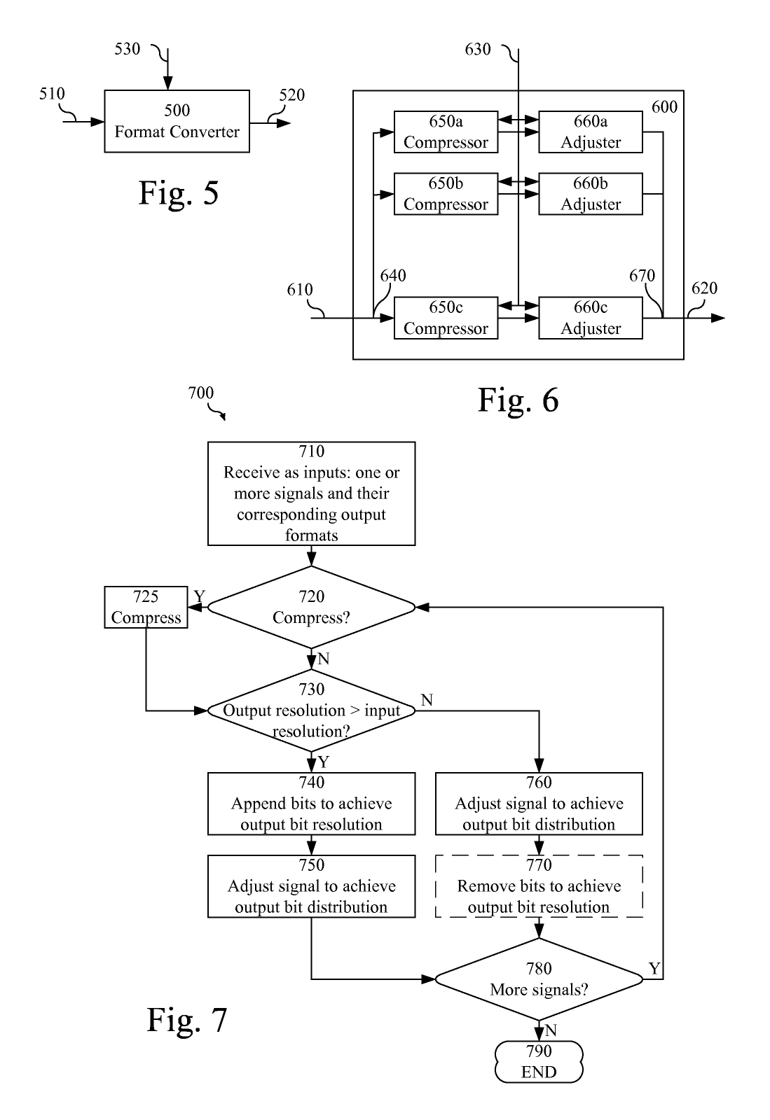

FIG. 5 illustrates an example format converter 500. The format converter accepts N_{CON} signals as input at 510 and outputs N_{CON} signals at 520. The signals input at 510 may have different format (i.e. different resolution and/or distribution, or put differently different number of integer and/or fractional bits), and so may the signals output at 520. The format converter 500 receives parameters A_{i,CON}, B_{i,CON}, i=1, 2, . . . , N_{CON} as inputs at 530, where A_{i,CON}, B_{i,CON} are parameters indicating the number of integer and fractional bits respectively of signal i after conversion, and converts the input signals to signals having the required format specified by the parameters input at 530. The format converter may include functionality to append bits and shift the representation similarly to what has been explained above for the format aligner. Further, the format converter may comprise compressor functionality to be able to compress the amplitude of input signals before changing the format. This is particularly helpful if the input signal amplitude is too large to fit within the output format given by the parameters input at 530. Thus, a means to avoid clipping of the signal due to a small number of integer bits in the format after convention is provided, while still preserving the detailed signal aspects of the least significant bits by avoiding a pure volume decrease before the format conversion. It is to be understood that the inputs at 530 can be any form of indication of the required output format (e.g. resolution and distribution in stead of number of integer and fractional bits).

FIG. 6 is a more detailed illustration of an example format converter 600. Inputs 610 and 630 substantially correspond to inputs 510 and 530 of FIG. 5 respectively. Output 620 substantially corresponds to output 520 of FIG. 5.

The example format converter 600 has a separate processing chain 650a-660a, 650b-660b, 650c-660c for each of the N_{CON} input signals. At 640, the input signals are provided to their respective processing chain. Supposing that signal 1 is provided to processing chain 650a-660a, it is first determined based on the required output format for signal 1 (input via 630) whether signal 1 needs to be compressed. This determination may, for example, be done in a separate control unit or in compressor 650a as is the case in the example format converter 600. If no compression is needed, compressor 650a is simply bypassed. If compression is needed, it is performed by compressor 650a. The compressed (or bypassed) signal is then provided to a signal adjuster 660a, that converts the compressed signal 1 to the specified format. The signal adjuster 660a may comprise functionality to append most significant bits and/or least significant bits, to discard least significant bits and/or most significant bits, and/or to left- and/or right-shift signal representations. The other processing chains 650b-660b, 650c-660c have similar functionality as the described processing chain 650a-660a. The converted signals may be provided as separate outputs or may combined at 670 to a single output (e.g. in a data structure or as a sequence of signal samples from different signals).

FIG. 7 illustrates example operations 700 performed, for example, by any of the format converters 500, 600 of FIGS. 5 and 6 respectively. At step 710, the format converter receives the audio signal inputs and the output format parameters (e.g. A_{i,CON}, B_{i,CON}, i=1, 2, . . . , N_{CON}).

In step 720, it is determined whether any compression is needed for a particular signal (signal i). In some embodiments, the determination is based on the input and output formats of the signal. In some embodiments, it is determined that compression is needed if the absolute value of the maximal amplitude of the input signal exceeds Z^{Y}−1, where Y=A_{i,CON}+Bᵢ and Z is the mathematical number base of the symbol representation (e.g. Z=2 for a bit representation).

If compression is needed, this is performed in step 725 and the process then proceeds to step 730. If no compression is needed the process moved from step 720 directly to step 730.

Then, in steps 730 to 770, the input signals are transformed to the format defined by the input parameters. In this embodiment, the transformation is performed in a particular manner as will be described in the following. However, it should be understood that there are many other ways to perform the transformation (e.g. appending bits, discarding bits, and/or shifting representations in other combinations and orders).

In step 730, it is determined whether or not the total number of bits in the input format is less than the total number of bits in the output format.

If the total number of bits in the input format is less than the total number of bits in the output format, the process proceeds to step 740, where a number of most or least significant bits are appended to the signal sample to achieve the required output signal resolution (i.e. format size/width). The number of appended bits equals the number of fractional and integer bits that are missing in the signal sample to have the as determined required defined by the input parameters, i.e. X=(A_{iCON}+B_{iCON})−(Aᵢ+Bᵢ), where X is the number of appended bits. Then, in step 750, the signal is adjusted (e.g. by left-shifting or right-shifting the representation) to achieve the required distribution defined by the input parameters. If B_{i,CON}<Bᵢ, then step 740 may comprise appending most significant bits and step 750 may comprise left-shifting the representation. Otherwise, step 740 may comprise appending least significant bits and step 750 may comprise right-shifting the representation. After adjusting the signal in step 750, the process proceeds to step 780.

If the total number of bits in the input format is not less than the total number of bits in the output format, the process proceeds from step 730 to step 760, where the signal is adjusted (e.g. by left-shifting or right-shifting the representation) to achieve the required distribution defined by the input parameters. If B_{i,CON}<Bᵢ, then step 760 may comprise left-shifting the representation. Otherwise, step 760 may comprise right-shifting the representation. In step 770, the bits that end up outside the representation after the shifting operation of step 760 are discarded (or removed) to achieve the required output signal resolution (i.e. format size/width). Depending on the compression of steps 720 and 725, the discarded most significant bits after a left-shift operation should not comprise any significant information. Discarded least significant bits after a right-shift operation may comprise information, and removing them may introduce some amount of quantization noise. Step 770 is described as optional since the removal may be seen as implicit in the shifting operations of step 760. After step 770, the process proceeds to step 780.

In step 780, it is determined whether there are more input signals to transform. If that is the case, the process returns to step 720 to transform another signal to the required format. Steps 720-780 are iterated until all input signals have been transformed. Then the process ends at step 790.

Although not shown in FIG. 7, the output signals from a format converter may also be tagged with an indicator of the output format in some embodiments, similarly to what has been described above.

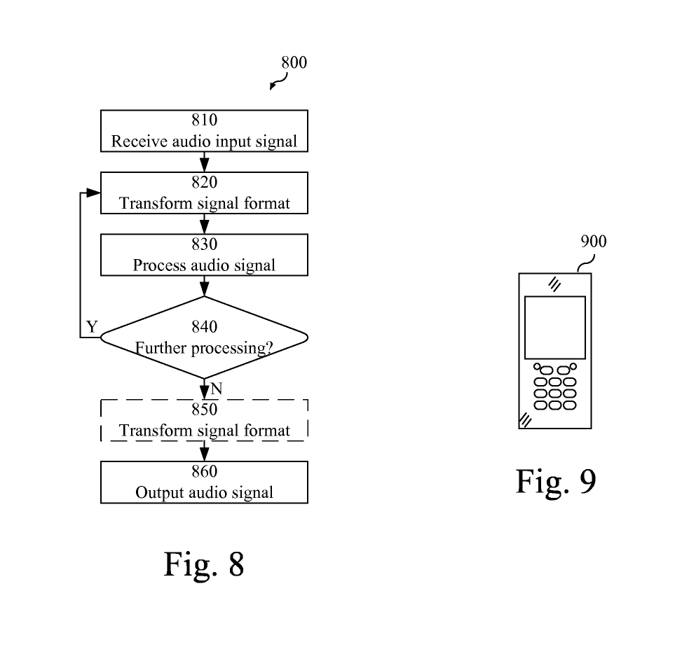

FIG. 8 illustrates example operations 800 performed by an audio signal processing system according to embodiments of the invention. For example, the example operations 800 may be performed by any of the systems 100a, 100b, 200 of FIGS. 2A and 2B respectively.

In step 810, the audio system receives one or more audio input signals (possibly with different formats). In step 820, the input signals are transformed to another format that is suitable for or required by the processing to be applied in step 830, for example using either (or possibly both) a format converter or a format aligner. Step 820 may, for example, employ any of the methods as described in connection to FIGS. 4 and 7 respectively. In step 830, the thus transformed signals are processed using, for example, any known and/or future audio processing algorithms. In step 840 it is determined whether the audio system processing chain comprises any further processing steps. If that is the case, the process returns to step 820. Steps 820 and 830 are iterated (possibly with different algorithms employed in each iteration of step 830) until the audio system processing chain does not comprise any further processing steps. Then the process continues to optional step 850, where the processed signal(s) are transformed to a format that is suitable for or required by the audio sink that is to receive the processed signal(s). Step 850 may, for example, employ any of the methods as described in connection to FIGS. 4 and 7 respectively. In step 860, the audio signals are output from the audio signal processing system to one or more sinks.

In the following, the format aligner and the format converter will be further exemplified. In the description below, digital audio signal n will be denoted Channel_n(An,Bn), n=1, . . , N. Thus, signal n is tagged with the bit-distribution in that An denotes the number of integer bits (possibly minus in the cases where the representation comprises a sign bit) and Bn denotes the number of fractional bits. As an example, S(0,15) is a notation for the Pulse Coded Modulation (PCM) format describing samples in the range of [−1, . . . , 1] using 16 bit-resolution where one bit (the sign bit) is used as integer bit and 15 bits are used as fractional bits.

In general, the signals may be scalars, vectors or matrices depending on whether mono-, stereo- or multi-channel signals are transported through and processed by the audio system, and whether they are transported and processed as samples or as arrays.

As mentioned before, the signals may be tagged with information indicating the current resolution and distribution of a signal. For example the A and B parameters may be propagated along with the signal samples as will be the case in the examples that follows. Alternatively, other parameters may be used to convey the necessary information (e.g. a resolution parameter and a distribution parameter). For an array based implementation it is sufficient if the array is tagged if all samples are equally formatted.

An alternative to tagging the signals with the necessary format information may be to propagate the necessary format information between units of the audio signal processing system independently from the signal propagation. However, such a solution is at risk of being more resource demanding. It would also require additional communication channels between the units dedicated for this purpose.

Generally, embodiments of the invention provide means for conveying/communicating necessary format information regarding the signal(s) to the various units of the audio processing system. One efficient way to achieve this is to include a format description in the sample carrying structure as will be assumed in the following.

In the following examples, the format description is included in the sample by using signal encapsulation, for example as illustrated in the following pseudo-code (where An includes any headroom bits and Bn includes any precision bits):

```
struct{
    void* Channel_1;
    void* Channel_2;
    ...
    void* Channel_N;
    ...
    uint A1;
    uint B1;
    uint A2;
    uint B2;
    ...
    uint AN;
    uint BN;
    ...
    unit H;
    unit K
}
```

In some embodiments, one or both of the parameters H and K are not included in the signal encapsulation.

As mentioned above, the format aligner may receive parameters H and K as inputs, denoting the number of bits used to represent the size of the headroom and the number of precision bits used to lower the noise floor, respectively. The parameters H and K may be used to guarantee a minimum amount of headroom bits and noise floor bits among the signals aligned by the format aligner.

In an example format aligner, the formats (A1,B1), (A2,B2), . . . , (AN,BN) of the input signals are extracted from the signal encapsulation. The required bit resolution (RequiredSize) to be used for the representation of the output signals may be determined as (where AI is the number of integer bits in the output format and BI is the number of fractional bits in the output format, compare with step 420 of process 400 in FIG. 4):
AI=max(An)+H, n=1, . . . , N
BI=max(Bn)+K, n=1, . . . , N
RequiredSize=AI+BI;

The example format aligner then uses RequiredSize and BI to align the input signals in terms of format so that each output signal has the same resolution and distribution (or put otherwise, the same number of integer and fractional bits respectively). Thus each of the output signals may be comparable in amplitude to any of the other output signals and will have one and the same common bit resolution.

The alignment may be achieved by adjusting the representation based on the input format and the output format. The size of the output samples is determined by choosing the correct variable size of the hardware architecture that is equal to or larger than RequiredSize. Then each of the resized signals may be shifted (e.g. based on BI) to achieve the required output distribution. The following pseudo-code describes an example alignment of signals (compare with steps 430, 440, 450, 460 of process 400 in FIG. 4):

| | |
|---|---|
| Channel_n; | input signal with format (An,Bn), n =1,...,N |
| Ouput_Channel_n; | aligned output signal with format (AIn,BI) |
| AI; | number of required integer bits |
| BI; | number of required fractional bits |
| << | leftshift operator |
| ReqSize | type with at least RequiredSize number of bits |

```
If Ak == Am && Bj == Bi && K == 0 (for k,m,j,i = 1,...,N)
    AlignmentRequired = False
else
    AlignmentRequired = True
end
for n = 1,...,N,
    If ConversionRequired == True,
        Ouput_Channel_n = ((ReqSize) Channel_n) << (BI −Bn))
        AIn = An + H
        Bn = BI
    else
        Ouput_Channel_n = Channel_n
    end
end
```

In this embodiment, H bits are added on top of the An integer bits. Thus, AIn=An+H will preserve the information concerning the dynamic range (AIn+BI) for each output signal. It may be observed that there is a difference in this embodiment between AIn and BI in that the latter is constant for all aligned signals. Hence, AIn+BI is less than or equal to ReqSize, which means that for some configurations one signal can utilize all bits while others only utilize a subset of the bits in the configuration.

The headroom bits are added as guard bits and finds a purpose if an operation results in an amplification above the An integer bits.

An advantage with tagging the aligned signals with AIn is that, if the signal is input to a format converter later in the processing chain, knowledge of AIn (=An+H) may be helpful to more accurately determine if compression is required. For example, if AIn=ReqSize−BI it may be determined that compression should be applied if the amplitude exceeds a threshold (for example as explained in connection to FIG. 7). Using AIn in this way may, in some embodiments, result in that the compressor operation is executed more frequently.

AIn may also be used to determine the maximum dynamic range (in dB: 20 log₁₀(2^{AIn+BI}), for example, for the purpose of dynamic range compression.

For example, inputting S1(0,15), S2(0,15), H=4 and K=12 to the above format aligner would result in A1=A2=4, BI=27 and ReqSize=32. Another example where S1(0,15), S2(8,7), H=5 and K=5 is input would result in A1=5, A2=13, BI=20, RequiredSize=34 (hence a ReqSize=64 could be used). If S1(0,15), S2(0,19), H=4 and K=8 is input, the alignment would result in A1=A2=4, BI=27 and ReqSize=32 (i.e. 32-bit processing). The output signals may, for example, be tagged with (An, Bn)=(AIn,BI)=(An+H,BI) as in the pseudo-code and examples above. In another example the output signals may be tagged with (An, Bn)=(An,BI) if H and K are included in the signal encapsulation as described above.

In a general audio processing system using software implementation of the format aligner, an implementation of a format alignment unit may require multiple implementations of the above algorithm (e.g. several instances of the function) if the available variable types (ReqSize) that are suitable for the corresponding hardware need to be known at compilation of the software. Depending on the implementation, these multiple implementations can be achieved in a compact form implementation, e.g. utilizing macros and function pointers.

As mentioned above, the format converter receives as inputs parameters Azn, Bzn, for n=1, 2, . . . , N, denoting the format required for output signal n. The format converter converts input signals with input formats (An,Bn), n=1, 2, . . . , N, to output signals with output formats (Azn,Bzn). The format converter comprises two main parts, compressor and format adjuster. The compressor is used to compress the amplitude of a signal if it is required for the signal to fit within the defined output format. The adjuster resizes (e.g. by appending and/or removing bits) and displaces (e.g. by shifting) the representation format to achieve the resolution and distribution as required by the output format (Azn,Bzn).

First the format converter determines whether there is a need for compression (compare with step 720 of process 700 in FIG. 7). In some embodiments, this determination may apply the following conditions. If Azn<An, then the signal amplitude of the input signal may be larger than the maximum amplitude that can be represented by the output format and signal n may need to be compressed to be able to fit into the output format. On the other hand, if Azn>=An, then it is certain that the signal amplitude of the input signal is not larger than the maximum amplitude that can be represented by the output format and there is no need for compression. In some embodiments, it is determined that compression is required if the maximum absolute value of the amplitude of input signal n is larger than Z^{Y}−1, where Y=(Azn+Bn) and Z is the mathematical number base of the symbol representation (i.e. Z=2 for a binary bit representation).

In some embodiments, a compression algorithm as disclosed in U.S. Pat. No. 6,741,966 may be used for the compression functionality of the format converter.

According to some embodiments, the compressor operates as an adaptive gain unit. The compressor may also comprise delaying the input signal before actual compression, which may provide possibility to use a look ahead time to account for future sample values in the compression. In some embodiments, the processing of the compressor may be divided into three phases, where each phase has a length of a predetermined number of samples. The three phases may comprise an attack phase (where the gain is decreased, which corresponds to a decreased overall amplitude), a release phase (where the gain is increased, which corresponds to an increased overall amplitude), and a hold phase (where the gain is kept constant and, consequently, the amplitude is unaffected). See U.S. Pat. No. 6,741,966 for further details of an example compressor implementation.

It is noted, however, that the invention is by no means limited to this particular compressor implementation. Contrarily, any suitable compressor (i.e. any compressor that is able to sufficiently lower the amplitude of the input signal so that it fits within the output signal format) may be used. Even a straightforward pure gain control may be used (although maybe not optimal in terms of precision quality).

When signal n has passed the compressor and potentially has been compressed (if determined that compression was needed), it may, in some embodiments, be guaranteed that the maximal absolute value of the amplitude of the signal is such that bits that are more significant than the (Azn+Bn) least significant bits of the signal contain no information (e.g. these bits may be either all 0 or all 1 depending on if signal n is positive or negative).

An adjustment to the required format (Azn,Bzn) after compression may, in some embodiments, comprise resizing and shifting of the representation (compare with the format alignment, e.g. steps 430 and 440 of process 400 in FIG. 4) and may, for example, be obtained as follows in pseudo code (compare with steps 730, 740, 750, 760, 770, 780 of process 700 in FIG. 7):

| | |
|---|---|
| Channel_n; | input signal with format (An,Bn) |

Output_Channel_n;output signal with format (Azn,Bzn)

| | |
|---|---|
| ReqSize; | Required size, hardware dependent size |
| | larger than or equal to Azn+Bzn, n=1,...,N |
| << | leftshift operator |
| >> | rightshift operator |

```
for n=1,...,N
  if Azn+Bzn <= An+Bn,
    if Bn >= Bzn,
        Output_Channel_n = (ReqSize)(Channel_n >> Bn−Bzn)
    else
        Output_Channel_n = (ReqSize)( Channel_n << Bzn−Bn)
    end
  else
    if Bn >= Bzn,
        Output_Channel_n = ((ReqSize) Channel_n) >> Bn−Bzn
    else
        Output_Channel_n = ((ReqSize) Channel_n) << Bzn−Bn
    end
  end
end
```

In a general audio processing system using software implementation of the format converter, an implementation of a format converter unit may—as for the format aligner—require multiple implementations of the above algorithm (e.g. several instances of the function) if the available variable types (ReqSize) that are suitable for the corresponding hardware need to be known at compilation of the software.

It is noteworthy that the above adjustment operation of the above example format converter when (Azn+Bzn>An+Bn) and (Bn<Bzn) corresponds to the adjustment operation in the example format aligner given in pseudo code above, which may provide for reuse of functionality in some hardware and/or software implementations.

Embodiments of the invention may be used in a standardized audio framework, such as the OpenMax IL framework (see for example www.khronos.org/openmax). The format aligner and the format converter may be viewed as two OpenMax IL components.

FIG. 9 illustrates an example mobile terminal 900 having audio rendering capabilities. The mobile terminal 900 comprises an audio signal processing system according to embodiments of the invention. The mobile terminal 900 may, for example, comprise an arrangement as described in connection to any of FIGS. 2A and 2B.

The described embodiments of the invention and their equivalents may be realised in software or hardware or a combination thereof. The format aligner and/or the format converter may be embodied as program functions which are called and instantiated as required by the particular audio processing system. The signals and/or signal samples and/or collections of signals and/or signal samples may be embodied as data structures in a software realization of embodiments of the invention. Some embodiments may be performed by general-purpose circuits associated with or integral to a communication device, such as digital signal processors (DSP), central processing units (CPU), co-processor units, field-programmable gate arrays (FPGA) or other programmable hardware, or by specialized circuits such as for example application-specific integrated circuits (ASIC). All such forms are contemplated to be within the scope of the invention.

The invention may be embodied within an electronic apparatus comprising circuitry/logic or performing methods according to any of the embodiments of the invention. The electronic apparatus may, for example, be an audio rendering device, a media player, a communication device, a portable or handheld mobile radio communication equipment, a mobile radio terminal, a mobile telephone, a communicator, an electronic organizer, a smartphone, a computer, a notebook, a mobile gaming device, or a (wrist) watch.

According to some embodiments of the invention, a computer program product comprises a computer readable medium such as, for example, a diskette or a CD-ROM. The computer readable medium may have stored thereon a computer program comprising program instructions. The computer program may be loadable into a data-processing unit, which may, for example, be comprised in an audio processing device such as a mobile terminal. When loaded into the data-processing unit, the computer program may be stored in a memory associated with or integral to the data-processing unit. According to some embodiments, the computer program may, when loaded into and run by the data-processing unit, cause the data-processing unit to execute method steps according to, for example, the methods shown in any of the FIGS. 4, 7 and 8.

The invention has been described herein with reference to various embodiments. However, a person skilled in the art would recognize numerous variations to the described embodiments that would still fall within the scope of the invention. For example, the method embodiments described herein describes example methods through method steps being performed in a certain order. However, it is recognized that these sequences of events may take place in another order without departing from the scope of the invention. Furthermore, some method steps may be performed in parallel even though they have been described as being performed in sequence.

In the same manner, it should be noted that in the description of embodiments of the invention, the partition of functional blocks into particular units is by no means limiting to the invention. Contrarily, these partitions are merely examples. Functional blocks described herein as one unit may be split into two or more units. In the same manner, functional blocks that are described herein as being implemented as two or more units may be implemented as a single unit without departing from the scope of the invention.

Hence, it should be understood that the limitations of the described embodiments are merely for illustrative purpose and by no means limiting. Instead, the scope of the invention is defined by the appended claims rather than by the description, and all variations that fall within the range of the claims are intended to be embraced therein.

1. A digital audio signal processing system comprising:
at least one input arranged to receive at least a first digital audio signal having a first format comprising a first symbol resolution and a first symbol distribution;
at least one first format transformer arranged to transform the first digital audio signal to a second digital audio signal having a second format comprising a second symbol resolution which is different from the first symbol resolution and a second symbol distribution which is different from the first symbol distribution based on at least a first parameter and a second parameter, wherein the first parameter is associated with a number of integer symbols of the second format and the second parameter is associated with a number of fractional symbols of the second format; and
at least one digital audio signal processor arranged to process the second digital audio signal to produce a third digital audio signal.

2. The digital audio system of claim 1, wherein the third digital audio signal has a third format comprising a third symbol resolution which is equal to the second symbol resolution and a third symbol distribution which is equal to the second symbol distribution, further comprising:
at least one second format transformer arranged to transform the third digital audio signal to a fourth digital audio signal having a fourth format comprising a fourth symbol resolution which is different from the third symbol resolution and a fourth symbol distribution which is different from the third symbol distribution based on at least a third parameter and a fourth parameter, wherein the third parameter is associated with a number of integer symbols of the fourth format and the fourth parameter is associated with a number of fractional symbols of the fourth format; and
at least one output arranged to provide at least the fourth digital audio signal.

3. The digital audio system of claim 1, wherein the first parameter comprises the number of integer symbols of the second format and the second parameter comprises the number of fractional symbols of the second format.

4. The digital audio system of claim 3, wherein the first format transformer comprises at least one compressor arranged to compress the first digital audio signal.

5. The digital audio system of claim 4, wherein the compressor is arranged to compress the first digital audio signal if the absolute value of the absolute value of the maximal amplitude of the first digital audio signal exceeds Z^{Y}−1, where Y equals a sum of the number of integer symbols of the second format and a number of fractional symbols of the first format and where Z is the mathematical number base of the symbol representation.

6. The digital audio system of claim 3, wherein the first format transformer comprises a format width adjuster arranged to append or remove a number of symbols to the first digital audio signal to provide the second digital audio signal with the second symbol resolution.

7. The digital audio system of claim 3, wherein the first format transformer comprises a symbol distribution adjuster arranged to shift the first digital audio signal to provide the second digital audio signal with the second symbol distribution.

8. The digital audio system of claim 3, wherein the first format transformer is arranged to transform a plurality of digital audio signals to a corresponding plurality of transformed digital audio signals each having a transformed format, for each of the plurality of digital audio signals based on at least a respective first parameter and a respective second parameter, wherein the respective first parameter comprises a number of integer symbols of the corresponding transformed format and the respective second parameter comprises a number of fractional symbols of the corresponding transformed format.

9. The digital audio system of claim 1, wherein the first parameter comprises an indication of a minimum number of headroom symbols of the second format and the second parameter comprises an indication of a minimum number of precision symbols of the second format.

10. The digital audio system of claim 9, wherein the first format transformer comprises a format width adjuster arranged to append a number of symbols to the first digital audio signal, wherein the number of symbols is equal to or larger than a sum of the minimum number of headroom symbols and the minimum number of precision symbols, to provide the second digital audio signal with the second symbol resolution.

11. The digital audio system of claim 9, wherein the first format transformer comprises a symbol distribution adjuster arranged to shift the first digital audio signal to provide the second digital audio signal with the second symbol resolution.

12. The digital audio system of claim 9, wherein the first format transformer is arranged to determine the second format based on the first and second parameters and on the first format of the first digital audio signal.

13. The digital audio system of claim 9, wherein the first format transformer is arranged to transform a plurality of digital audio signals, each having a respective first format, to a corresponding plurality of transformed digital audio signals each having a same second format, based on at least the first parameter and the second parameter.

14. The digital audio system of claim 13, wherein the first format transformer is arranged to determine the second format based on the first and second parameters and on the respective first formats of the plurality of digital audio signals.

15. The digital audio system of claim 13, wherein the second symbol resolution is a sum of: the minimum number of headroom symbols, the minimum number of precision symbols, a maximum number of integer symbols among the respective first formats, and a maximum number of fractional symbols among the respective first formats.

16. The digital audio system of claim 1, wherein the first format converter is further arranged to tag the second digital audio signal with an indicator of the second format.

17. The digital audio system of claim 1, wherein each symbol consists of a bit.

18. An electronic apparatus comprising the system according to claim 1.

19. The electronic apparatus according to claim 18, wherein the electronic apparatus is an audio rendering device, a media player, a communication device, or a mobile telephone.

20. A computer program product comprising a computer readable medium, having thereon a computer program comprising program instructions, the computer program being loadable into a data-processing unit of an audio processing device and adapted to cause the data-processing unit to execute, when the computer program is run by the data-processing unit, at least the steps of:
receiving at least a first digital audio signal having a first format comprising a first symbol resolution and a first symbol distribution;
transforming the first digital audio signal to a second digital audio signal having a second format comprising a second symbol resolution which is different from the first symbol resolution and a second symbol distribution which is different from the first symbol distribution based on at least a first parameter and a second parameter, wherein the first parameter is associated with the number of integer symbols of the second format and the second parameter is associated with the number of fractional symbols of the second format; and
processing the second digital audio signal to produce a third digital audio signal.
